(19) United States
(12) Patent Application Publication
(10) Pub. No.: US 2017/0072554 A1
(43) Pub. Date: Mar. 16, 2017

(54) SCREWDRIVER CAPABLE OF ACCOMMODATING SCREW BITS

(71) Applicant: A-TINA TOOLS CO., LTD., TAICHUNG CITY (TW)

(72) Inventor: KUN-CHEN CHEN, TAICHUNG CITY (TW)

(21) Appl. No.: 14/856,360

(22) Filed: Sep. 16, 2015

(51) Int. Cl. B25G 1/08

(52) U.S. Cl. CPC B25G 1/085

(57) ABSTRACT

A screwdriver has a handle, a cap, a shaft, and multiple screw bits; wherein the handle has two ends. The cap and the shaft are respectively disposed at the two ends of the handle. The multiple screw bits are received inside the handle. The handle has multiple chambers to contain the screw bits that differ in specifications. The handle has multiple first positioning structures. The cap has multiple second positioning structures complementary to the first positioning structures. Because the first positioning structures and the second positioning structures are engaged with each other, the cap cannot be rotated inadvertently, thereby preventing the screw bits dropping out from the handle inadvertently.

### BACKGROUND OF THE INVENTION

1. Field of the Invention

The present invention relates to a screwdriver, and more particularly to a screwdriver capable of accommodating screw bits for users to access the screw bits easily.

2. Description of Related Art

A traditional screwdriver comprises a handle and a shaft. The handle is applied for a user to hold and turn the screwdriver. The shaft has two ends, one of the ends of the shaft is axially connected with the handle, and the other end of the shaft has a blade. The blade is designed to fit a slot of a bolt and has different types. The bolt has a variety of specifications, and each specification has different types of slots varied in size. The blade of the traditional screwdriver is integrally formed on the shaft and is not suitable for different kinds of bolts. The user must prepare and carry multiple screwdrivers with different kinds of blades to fit with different kinds of bolts. The preparation and the carrying of the screwdrivers bring the user a lot of inconvenience.

To resolve the inconvenience of the traditional screwdriver, improvement of the traditional screwdriver is provided. With reference to FIG. 9, a conventional screwdriver comprises multiple screw bits 50, a handle 60, a cap 70, and a shaft. The screw bits 50 are received in the handle 60. The handle 60 has two ends and multiple chambers 61. The chambers 61 are applied to contain the screw bits 50. The cap 70 is screwed on the handle 60 at one end of the handle 60. The shaft is axially connected with the other end of the handle 60. The shaft has one end which is distal from the handle 60, and a socket is formed in the end of the shaft. The socket is designed to assemble the screw bits 50 that differ in specifications.

The conventional screwdriver is able to connect the screw bits 50 and has the multiple chambers 61 to contain the screw bits 50. The conventional screwdriver can bring the user convenience in use. However, the user has to screw off the cap 70 to access the screw bits 50. The designation of the cap 70 not only causes inconvenient access to the screw bits 50 but also likely causes inadvertent loss of the screw bits 50.

To overcome the shortcomings of the conventional screwdriver, the present invention provides a screwdriver to mitigate or obviate the aforementioned problems.

### SUMMARY OF THE INVENTION

The main objective of the present invention is to provide a screwdriver capable of accommodating screw bits; the screwdriver can easily store screw bits within its chamber to facilitate easy access to the screw bits.

The screwdriver comprises a handle, a cap, a shaft, and multiple screw bits; wherein the handle has two ends. The cap and the shaft are respectively disposed at the two ends of the handle. The multiple screw bits are received inside the handle. The handle has multiple chambers to contain the screw bits that differ in specifications. The handle has multiple first positioning structures. The cap has multiple second positioning structures complementary to the first positioning structures. Because the first positioning structures and the second positioning structures are engaged with each other, the cap cannot be rotated inadvertently, thereby preventing the screw bits from dropping out from the handle inadvertently.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a screwdriver in accordance with a first embodiment of the present invention;

FIG. 2 is an exploded perspective view of the screwdriver in FIG. 1;

FIG. 3 is a perspective view in partial section of the screwdriver in FIG. 1;

FIG. 4 is an operational cross sectional top view of the screwdriver in FIG. 1;

FIG. 5 is a cross sectional top view of the screwdriver along line 5-5 in FIG. 6;

FIG. 6 is a cross sectional side view of the screwdriver along line 6-6 in FIG. 5;

FIG. 7 is a cross sectional side view of the screwdriver along line 7-7 in FIG. 5;

FIG. 8 is a cross sectional top view of a second embodiment of a screwdriver in accordance with the present invention; and

FIG. 9 is an exploded perspective view of a conventional screwdriver.

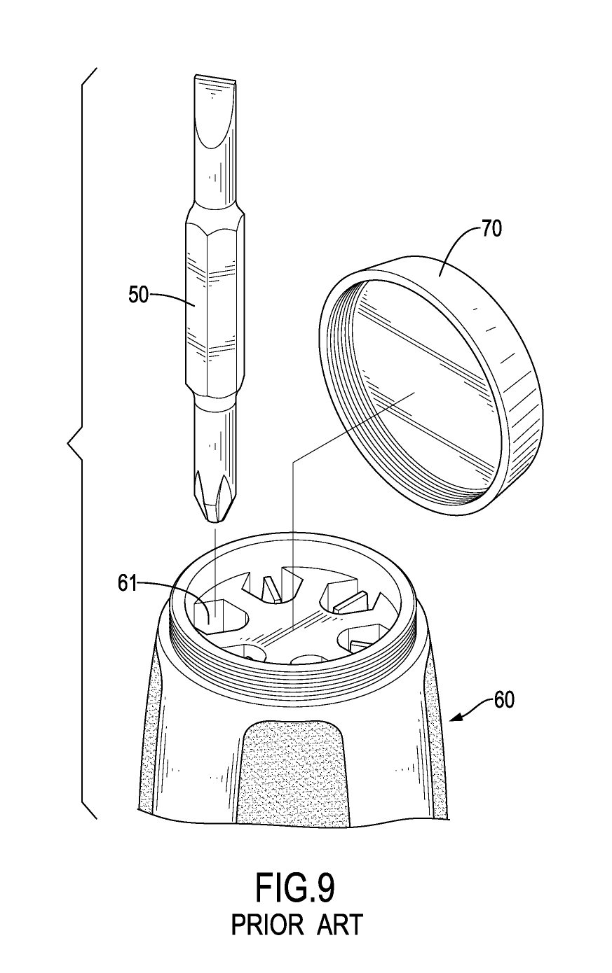

### DETAILED DESCRIPTION OF PREFERRED EMBODIMENT

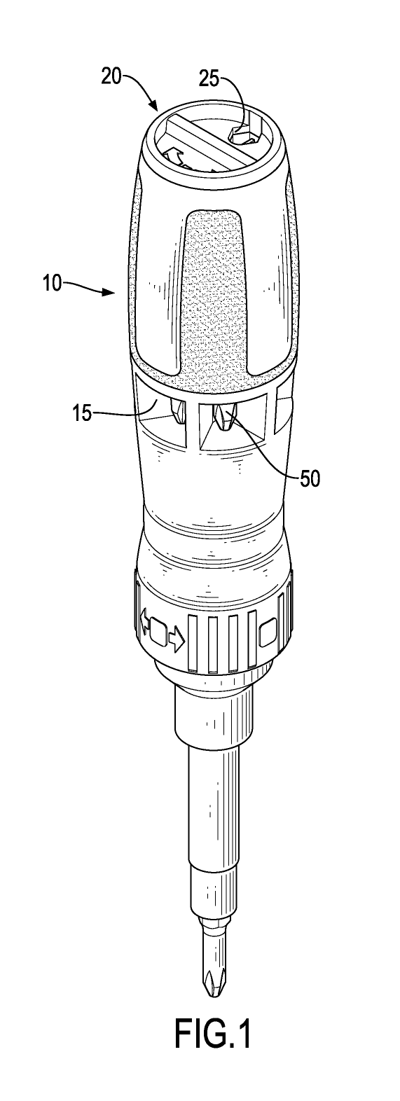

With reference to FIG. 1, a screwdriver in accordance with the present invention comprises a handle 10, a cap 20, a shaft, and multiple screw bits 50. The handle 10 has two ends. The cap 20 is mounted on the handle at one of the ends of the handle 10. The shaft is axially connected with the other end of the handle 10. The screw bits 50 are received inside of the handle 10.

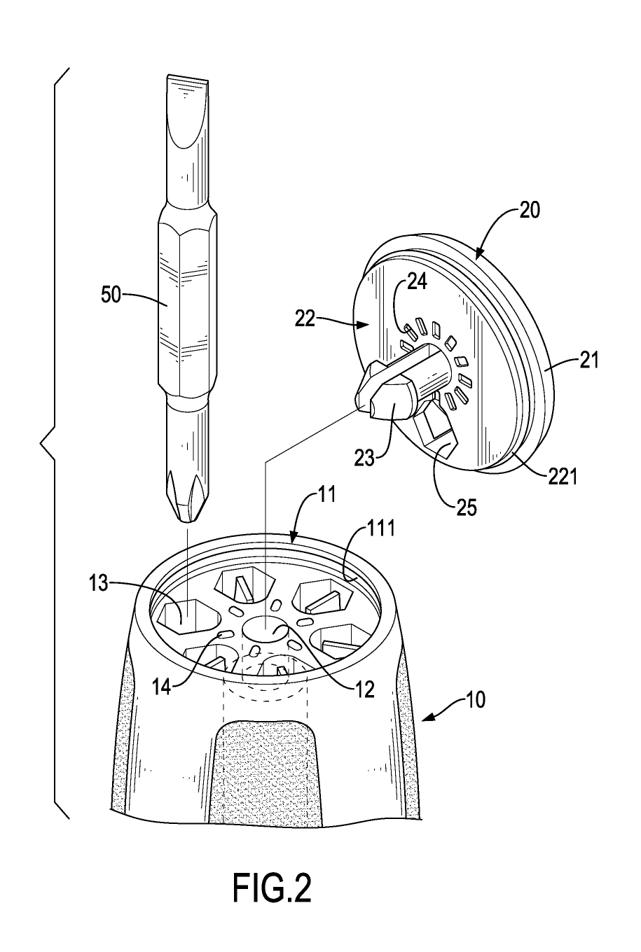

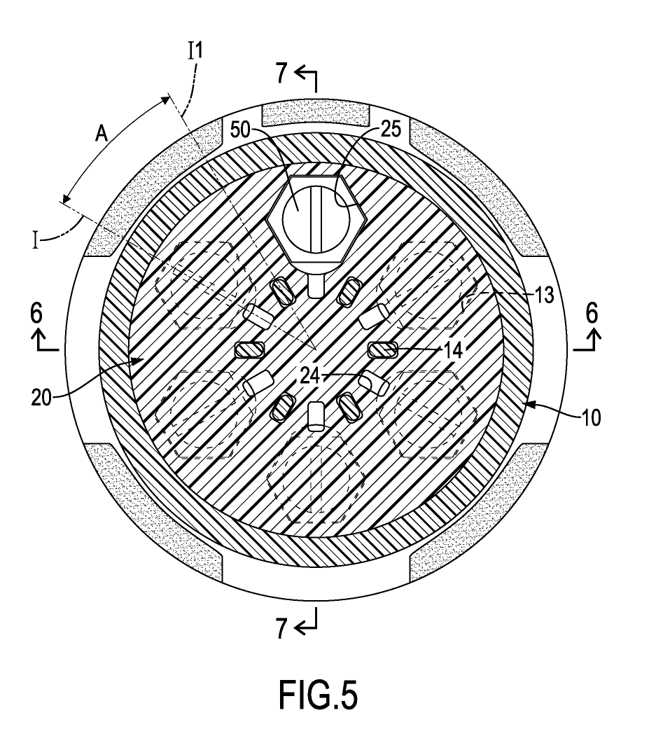

With reference to FIG. 1, FIG. 2, and FIG. 5, the handle 10 has an outer surface, a first assembling portion 11, a fastening hole 12, six chambers 13, six first positioning structures 14, and six observation holes 15. The first assembling portion 11 is a recess formed in one end of the handle 10. The first assembling portion 11 has a cross-section, an inner surface, a plane disposed at a bottom of the first assembling portion 11, an axis, and a groove 111. The cross-section of the first assembling portion 11 is circular. The groove 111 is annular and is formed in the inner surface of the first assembling portion 11. The fastening hole 12 is axially formed in the plane of the first assembling portion 11. The six chambers 13 are formed in the plane of the first assembling portion 11 and extend toward the other end of the handle 10. The chambers 13 are arranged around the axis of the first assembling portion 11 and disposed at equal angular intervals. Each chamber 13 has an outline and a first centroid, and the first centroid is a geometric center of the outline of the chamber 13. An imaginary line I is formed between the axis of the first assembling portion 11 and the first centroid of each chamber 13.

The six first positioning structures 14 protrude from the plane of the first assembling portion 11. The six first positioning structures 14 are arranged around the axis of the first assembling portion 11 and disposed at equal angular intervals. Each first positioning structure 14 has an outline and a first center, and the first center is a geometric center of the outline of the first positioning structure 14. A first imaginary line I1 is formed between the axis of the first assembling portion 11 and the first center of each first positioning structure 14. An angle A of thirty degrees is defined between one of the imaginary lines I and the first imaginary line I1 that is next to the imaginary line I.

The six observation holes 15 are formed through the outer surface of the handle 10. The six observation holes 15 communicate with the six chambers 13 respectively.

With reference to FIG. 2, the cap 20 has an abutting plate 21, a second assembling portion 22, a fixing component 23, twelve second positioning structures 24, and an accessing hole 25. The abutting plate 21 has a plane. The second assembling portion 22 is cylindrical and protrudes from the plane of the abutting plate 21. The second assembling portion 22 has an outer surface, a plane, an axis, a radial line extending from the axis of the second assembling portion 22, and a blocking protrusion 221. The blocking protrusion 221 is annular and is formed on the outer surface of the second assembling portion 22. The fixing component 23 axially protrudes from the plane of the second assembling portion 22.

The twelve second positioning structures 24 are recesses engaged with the first positioning structures 14. The twelve second positioning structures 24 are formed in the plane of the second assembling portion 22. The twelve second positioning structures 24 are arranged around the axis of the second assembling portion 22 and disposed at equal angular intervals. Each second positioning structure 24 has an outline and a second center, and the second center is a geometric center of the second positioning structure 24.

The accessing hole 25 is formed through the plane of the second assembling portion. The accessing hole 25 is disposed in an eccentric position on the plane of the second assembling portion 22 and corresponds in position to the chambers 13. The accessing hole 25 has an outline and a second centroid, and the second centroid is a geometric center of the outline of the accessing hole 25. The second centroid and the second center of one of the second positioning structures 24 are located at the radial line.

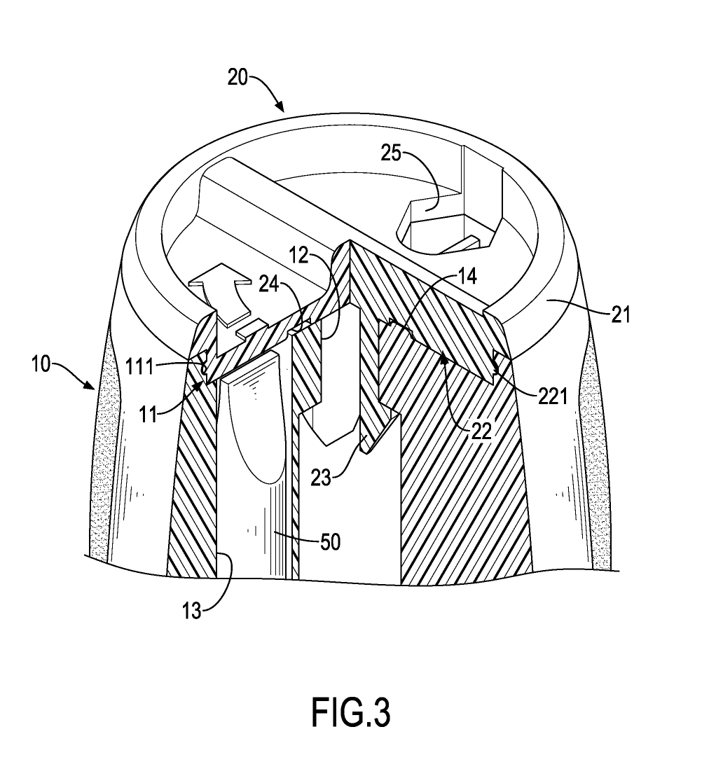

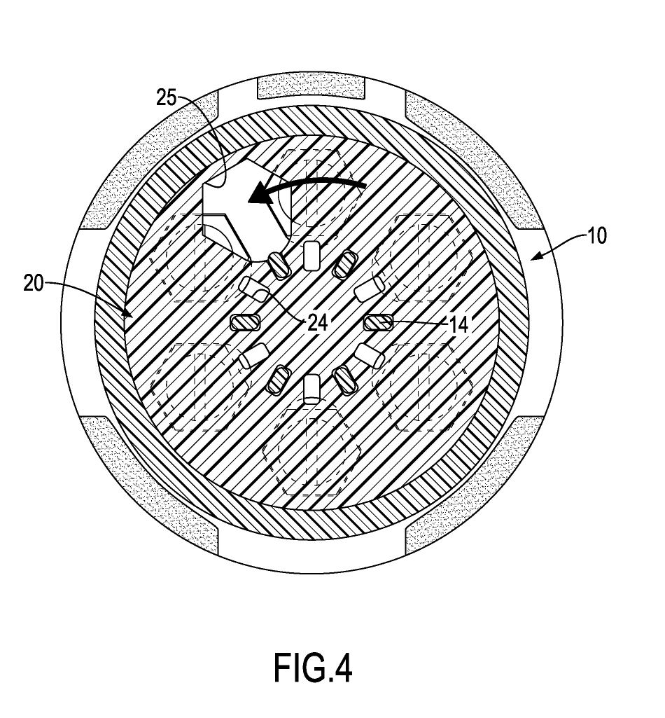

With reference to FIG. 2, FIG. 3, and FIG. 4, the second assembling portion 22 of the cap 20 is inserted into the first assembling portion 11 of the handle 10. The blocking protrusion 221 of the second assembling portion 22 is mounted in the groove 111 of the first assembling portion 11. The fixing component 23 of the cap 20 is inserted into the fastening hole 12 of the handle 10 and fixed in the handle 10. The twelve second positioning structures 24 are divided into two groups. The two groups of the second positioning structures 24 are disposed in an alternate manner. The screw bits 50 are contained in the chambers 13 of the handle 10 respectively.

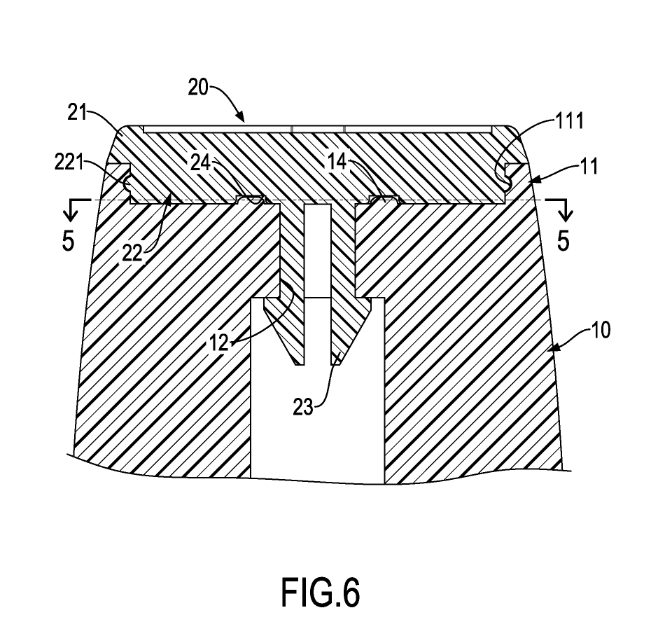

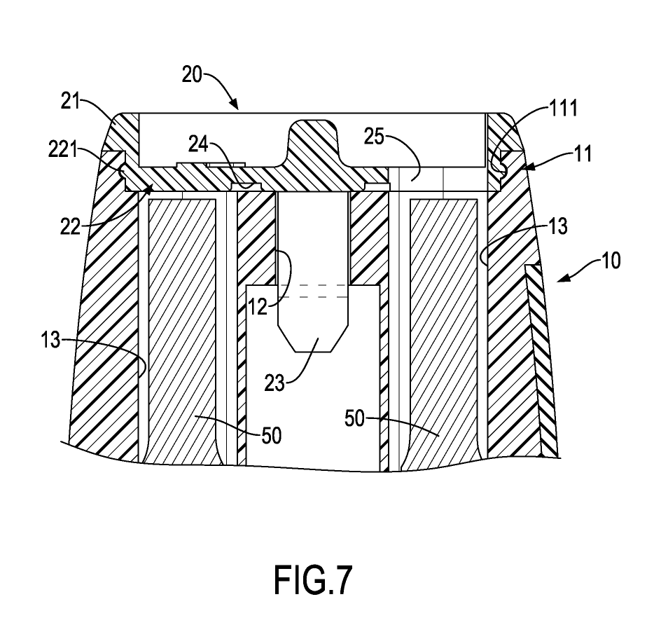

With reference to FIG. 4, the second positioning structures 24 of one of the two groups are engaged with the first positioning structures 14 of the handle 10. As such, the cap 20 cannot be rotated inadvertently and the screw bit 50 can be kept from dropping out from the accessing hole 25. With reference to FIG. 5, FIG. 6, and FIG. 7, to take one of the screw bits 50 out, the cap 20 is rotated to align the accessing hole 25 with one of the chambers 13. The screw bit 50 contained in the chamber 13 can be taken out from the accessing hole 25.

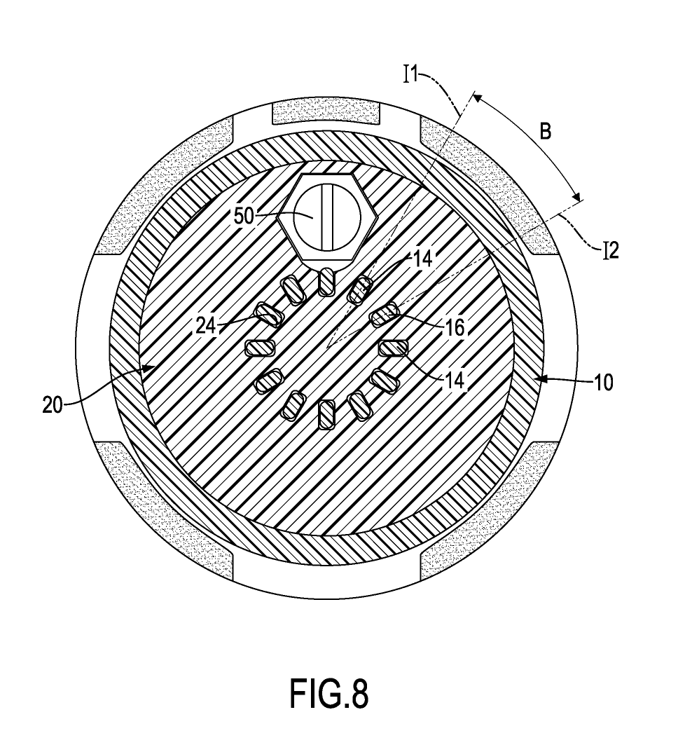

With reference to FIG. 8, the second embodiment of the present invention further comprises six third positioning structures 16.

The six third positioning structures 16 protrude from the plane of the first assembling portion 11. The six third positioning structures 16 are arranged around the axis of the first assembling portion 11 and disposed at equal angular intervals. Each third positioning structure 16 is disposed between two of the first positioning structures 14 that are adjacent to each other. Each third positioning structure 16 has an outline and a third center, and the third center is a geometric center of the third positioning structure 16. A second imaginary line 12 is formed between the axis of the first assembling portion 11 and the third center of each one of the third positioning structures 16. An angle B of thirty degrees is defined between one of the first imaginary lines I1 and the second imaginary line 12 which is next to the first imaginary line I1.

The first positioning structures 14 and the third positioning structures 16 are engaged with the second positioning structures 24 of the cap 20.

The screwdriver in accordance with the present invention has multiple chambers to contain the screw bits 50. The handle 10 has at least one first positioning structure 14. The cap 20 has at least one second positioning structure 24. Due to the at least one first positioning structure 14 and the at least one second positioning structure 24, the screw bit 50 can be kept from being dropped off when the cap 20 is rotated inadvertently. The handle 10 further comprises the third positioning structures 16 engaged with the second positioning structures 24 to keep the cap 20 from being rotated inadvertently.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A screwdriver comprising:
a handle having
two ends;
a first assembling portion formed at one of the ends of the handle and having
a plane and an axis;
multiple chambers formed in one of the ends of the handle on which the plane of the first assembling portion is formed, the chambers extending toward the other end of the handle and arranged around the axis of the first assembling portion, each chamber having an outline, a first centroid, and an imaginary line, the first centroid of each chamber being a geometric center of the outline of each chamber, and the imaginary line formed between the axis of the first assembling portion and the first centroid of each chamber; and
at least one first positioning structure each respectively having an outline, a first center, and a first imaginary line, the first center of each one of the at least one positioning structure being a geometric center of the outline of the first positioning structure, and the first imaginary line formed between the axis of the first assembling portion and the first center of each one of the at least one first positioning structure, wherein an angle is defined between the first imaginary line and one of the imaginary lines that is adjacent to the first imaginary line; and
a cap having
a second assembling portion rotatably mounted on the first assembling portion and having
a plane;
an axis; and
a radial line extending from the axis of the second assembling portion;
at least one second positioning structure each respectively having an outline and a second center, the second center of each one of the at least one second positioning being a geometric center of the second positioning structure, and the at least one second positioning structure respectively engaged with the at least one first positioning structure; and
an accessing hole formed through the plane of the second assembling portion and having an outline and a second centroid, the second centroid being a geometric center of the outline of the accessing hole, the second centroid and the second center of one of the at least one second positioning structure located at the radial line of the second assembling portion, and the accessing hole disposed in an eccentric position on the plane of the second assembling portion and corresponding in position to one of the chambers.

2. The screwdriver as claimed in claim 1, wherein
the chambers are implemented as six in amount;
the at least one first positioning structure is implemented as six in amount; and
an angle of thirty degrees is defined between the imaginary line of one of the chambers and the first imaginary line that is adjacent to the imaginary line.

3. The screwdriver as claimed in claim 2, wherein the at least one second positioning structure is implemented as twelve in amount; and
the twelve second positioning structures are arranged around the axis of the second assembling portion and disposed at equal angular intervals.

4. The screwdriver as claimed in claim 3, wherein
the at least one first positioning structure protrudes from the plane of the first assembling portion; each second positioning structure is a recess formed in the plane of the second assembling portion and engaged with one of the first positioning structures.

5. The screwdriver as claimed in claim 3, wherein
the first assembling portion is a recess and has a circular cross-section, and the plane of the first assembling portion is disposed at a bottom of the first assembling portion; and
the second assembling portion is cylindrical and is inserted in the first assembling portion.

6. The screwdriver as claimed in claim 3, wherein
the first assembling portion has an inner surface and a groove;
the groove is annular and is formed in the inner surface of the first assembling portion;
the second assembling portion has an outer surface and a blocking protrusion; and
the blocking protrusion is annular and is formed on the outer surface of the second assembling portion; the blocking protrusion is mounted in the groove.

7. The screwdriver as claimed in claim 3 further comprising six third positioning structures, wherein the six third positioning structures are formed around the axis of the first assembling portion and arranged at equal angular intervals; each third positioning structure is disposed between two of the first positioning structures that are adjacent to each other, and each third positioning structure has an outline and a third center;
the third center of each third positioning structure is a geometric center of the outline of the third positioning structure;
a second imaginary line is formed between the axis of the first assembling portion and the third center of each third positioning structure;
an angle of thirty degrees is defined between one of the first imaginary lines and the second imaginary line that is adjacent to the first imaginary line; and
the third positioning structures are engaged with the second positioning structures of the cap.

8. The screwdriver as claimed in claim 7, wherein
the first positioning structures and the third positioning structures protrude from the plane of the first assembling portion, the second positioning structures are recesses and engaged with the first positioning structures and the third positioning structures respectively, and each second positioning structure is formed in the plane of the second assembling portion.

9. The screwdriver as claimed in claim 8, wherein
the first assembling portion is a recess and has a circular cross-section, and the plane of the first assembling portion is disposed at a bottom of the first assembling portion; and
the second assembling portion is cylindrical and is inserted into the first assembling portion.

10. The screwdriver as claimed in claim 9, wherein
the first assembling portion has an inner surface and a groove,
the groove is annular and is formed in the inner surface of the first assembling portion;
the second assembling portion has an outer surface and a blocking protrusion; and
the blocking protrusion is annular and is formed on the outer surface of the second assembling portion, and the blocking protrusion is mounted in the groove.
